(19) United States
(12) Patent Application Publication
(10) Pub. No.: US 2013/0080657 A1
(43) Pub. Date: Mar. 28, 2013

(54) DATA TRANSMISSION DEVICE AND DATA TRANSMISSION METHOD

(71) Applicants: Takashi Yamaguchi, Osaka (JP); Hirokazu Kobayashi, Tokyo (JP); Satoshi Senga, Kanagawa (JP); Masaaki Harada, Kanagawa (JP)

(72) Inventors: Takashi Yamaguchi, Osaka (JP); Hirokazu Kobayashi, Tokyo (JP); Satoshi Senga, Kanagawa (JP); Masaaki Harada, Kanagawa (JP)

(73) Assignee: PANASONIC CORPORATION, Osaka (JP)

(21) Appl. No.: 13/698,923

(22) PCT Filed: Jul. 8, 2011
(86) PCT No.: PCT/JP2011/003231

§ 371 Date: Nov. 19, 2012

(30) Foreign Application Priority Data
Jun. 17, 2010 (JP) 2010-138349

(51) Int. Cl. G06F 15/173

(52) U.S. Cl. CPC G06F 15/17312
USPC 709/234

(57) ABSTRACT

A data transmission device (100) is provided with a transmission amount analysis unit (103) for analyzing the transmitted packet data amount with respect to a transmission window size which has been set by a transmission window size setting unit (102); a transmission parameter designation unit (104) for designating, according to the ratio of the transmitted packet data amount with respect to the transmission window size, different transmission powers, modulation methods, and code ratios for a transmission parameter setting unit (107); the transmission parameter setting unit (107) for setting the parameters that have been designated by the transmission parameter designation unit (104); and a transmission control unit (110) for reading transmission data from a transmission buffer (101) and transmitting the transmission data on the basis of the settings of the transmission parameter setting unit (107).

### TECHNICAL FIELD

The present invention relates to a data transmitting apparatus and a data transmitting method. More particularly, the present invention relates to a data transmitting apparatus and a data transmitting method for power saving in a communication network.

### BACKGROUND ART

Patent Literature 1 discloses a data transmission controlling method capable of a power control using a positive acknowledgment via a wireless link. The data transmission controlling method disclosed in Patent Literature 1 compares the volume of received reception acknowledgement response (Ack) predicted in transferring data with a certain transmission size, with the volume of actual received Ack and controls a transmission power depending on a comparison result.

FIG. 1 is a flowchart showing a data transmission controlling method disclosed in Patent Literature 1.

As shown in FIG. 1, in step S3, it is determined whether or not an Ack to transmitted data is received. In Step S6, a packet error rate (PER) is calculated as a ratio of the number of lost Acks to the number of expected Acks.

In step S7 and step S10, the PER is compared with two thresholds of the first threshold and the second threshold. Here, the first threshold is larger than the second threshold. When the PER is larger than the first threshold, that is to say, the PER is high, a transmission power is increased in step S8, and the PER is compared with the second threshold in step S10. When the PER is smaller than the second threshold, the transmission power is controlled to be reduced in step S11.

In data transmission in TCP (Transport Control Protocol), a change and a difference in a network state due to various factors such as a delay, jitter, and packet loss need to be considered.

Next, a TCP transmission/reception control will be described.

TCP controls a flow of data transmission and reception by employing a concept of a window. TCP flow control reports a reception window (generally, corresponding to the volume of free space in TCP reception buffer in a receiving side) to a transmitting side, thereby performing an adjustment such that the data volume which excesses the volume of free space is not transmitted to the receiving side. Specifically, a reception window is stored in a “window size” field of a TCP header and is reported using an Ack packet (a positive acknowledgment) from the receiving side to the transmitting side.

The TCP header further has an Ack number (the number of data to be received next) field and the receiving side simultaneously reports what data the receiving side has received, to the transmitting side, using the Ack number field of the Ack packet.

The transmitting side monitors the Ack, acquires an upper limit of the size of data which can be transmitted in a next transmission at one time, from a relationship between the size of transmitted data, the reception window reported by the Ack, and the Ack number, and does not transmit data which exceeds the upper limit.

Here, the size of data which can be transmitted without waiting the Ack, determined in the transmitting side, refers to a transmission window size. The transmitting side sequentially transmits data equivalent to the size of the transmission window on a per packet basis.

FIG. 2 is a control sequence diagram showing a TCP transmission/reception control. FIG. 2 (a) shows a transmission/reception control during normal communication and FIG. 2 (b) shows a transmission/reception control in a case where a packet loss occurs.

In FIG. 2, DATAn represents the nth packet data. ACKn represents an Ack reporting that data has been received up to the n-th packet data.

As shown in FIG. 2 (a), a TCP slow start control is performed for a certain period after the start of a transfer in normal communication. In the TCP slow start control, the receiving side transmits an Ack by updating a received packet number every time (DATA1 to ACK10) when the receiving side receives packet data. After that, when transferring is stably performed, the receiving side transmits one Ack for a plurality of packet data receptions (DATA 11 and thereafter) instead of transmitting the Ack every time.

FIG. 2 (a) shows an example case of transmitting one Ack for two packet data receptions.

When a packet data loss occurs and the receiving side receives packet data having a packet number other than the packet number of data to be received next, the receiving side reports the packet data loss to the transmitting side. Specifically, the receiving side transmits a duplicate Ack every time receiving packet data until the receiving side receives the lost packet data.

FIG. 2 (b) shows an example of transmission of the above duplicate Ack. In the example of FIG. 2 (b), it is assumed that a packet loss of DATA 11 occurs. The receiving side receives DATA 12 instead of the packet data of DATA 11 to be received next. This causes the receiving side to transmit an Ack reporting that the receiving side has received packet data up to DATA 10 (the 10th packet), every reception of the packet data after the reception of DATA 12.

### CITATION LIST

### Patent Literature

### PLT 1

Japanese Patent Application Laid-Open No. 2006-254505

### SUMMARY OF INVENTION

### Technical Problem

Such a conventional technique, however, performs a control for changing transmission power depending on the PER, and therefore, the receiving side continues to return the duplicate Ack to the transmitting side every packet data reception after packet data loss occurs. That is to say, in the conventional technique, once a data loss occurs, the number of Ack transmissions after the occurrence of the data loss in the receiving side increases, thereby increasing a load on the transmitting side receiving the Ack and a power consumption of a terminal on the receiving side.

The conventional technique cannot solve a problem of an increase in a load in the transmitting side and an increase in a power consumption of a terminal in the receiving side, which are caused by an increase in the number of duplicate Ack transmissions in the receiving side. Especially, in transferring data equivalent to a transmission window size, when a packet data loss occurs at an initial stage of the transferring, the number of duplicate Ack transmissions increases in the receiving side.

It is an object of the present invention to provide a data transmitting apparatus and a data transmitting method that suppress an occurrence of a packet data loss at an initial stage of a transfer, reduce the number of duplicate Ack transmissions in a receiving side, and thereby can reduce a load in the transmitting side and a power consumption of a terminal in the receiving side.

### Solution to Problem

A data transmission apparatus according to the present invention employs a configuration to include a transmission buffer that buffers transmission data; a transmission window size setting section that sets a transmission window size in the transmission buffer; a transmission volume analysis section that analyzes the data volume of a transmitted packet relative to the transmission window size set in the transmission window size setting section; a transmission parameter setting section that sets one or more transmission parameters for transmitting the transmission data, depending on the analytical results in the transmission volume analysis section; a transmission control section that reads the transmission data from the transmission buffer and transmits the transmission data based on the transmission parameters; and a data transmission section that transmits the transmission data received from the transmission control section.

A data transmission method according to the present invention employs a configuration to include the steps of: buffering the transmission data in a transmission buffer; setting a transmission window size in the transmission buffer; analyzing the data volume of transmitted packet relative to the set transmission window size; setting a transmission parameter for transmitting the transmission data depending on the analytical result; reading the transmission data from the transmission buffer and transmitting the transmission data based on the transmission parameter; and transmitting the transmission data received from the transmission control section.

### Advantageous Effects of Invention

According to the present invention, it is possible to suppress a packet data loss at an initial stage in transferring data equivalent to a transmission window size. As a result, it is possible to suppress an increase in the number of duplicate Ack transmissions in a receiving side and reduce a load in the transmitting side and a power consumption of a terminal in the receiving side.

### BRIEF DESCRIPTION OF DRAWINGS

FIG. 1 is a flowchart showing a conventional method of controlling a data transmission;

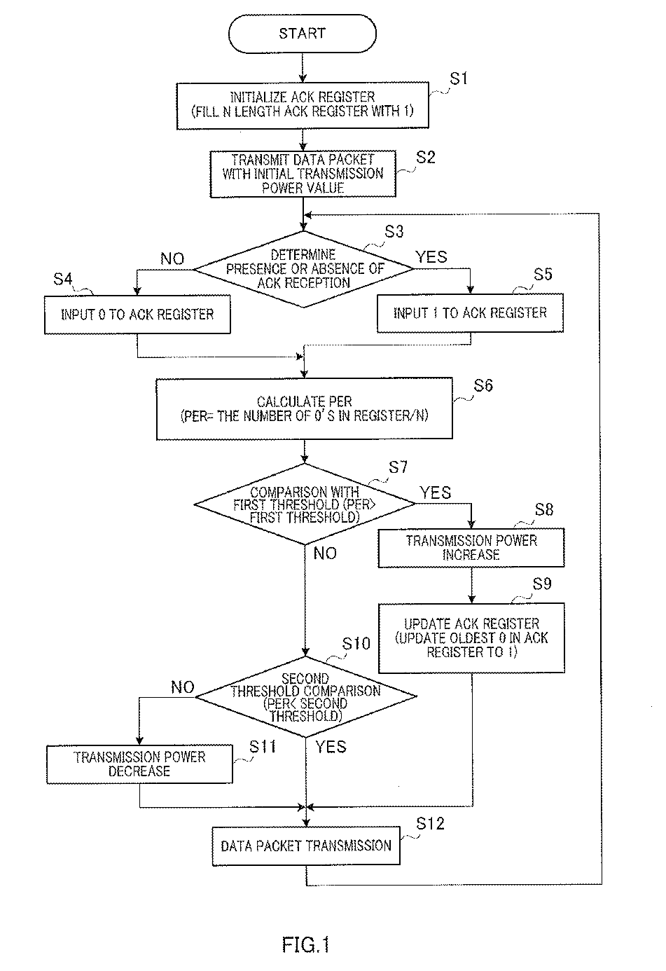

FIG. 2 is a control sequence diagram showing a conventional TCP transmission/reception control;

FIG. 3 is a diagram showing an example of a system configuration that a data transmitting apparatus according to Embodiment 1 of the present invention is applied;

FIG. 4 is a diagram showing an example of a system configuration that a data transmitting apparatus according to the above Embodiment 1 is applied;

FIG. 5 is a diagram showing a configuration of the data transmitting apparatus according to the above Embodiment 1;

FIG. 6 illustrates a transmission window size set in a transmission buffer in the data transmitting apparatus according to the above Embodiment 1;

FIG. 7 is a flowchart showing a transmission control in a data transmitting apparatus according to the above Embodiment 1;

FIG. 8 is a flowchart showing a transmission parameter setting process in a transmission parameter setting section in a data transmitting apparatus according to the above Embodiment 1;

FIG. 9 is a diagram showing a table to set values of transmission parameters based on the proportion of the transmitted data volume in a data transmitting apparatus according to the above Embodiment 1;

FIG. 10 is a diagram showing a setting table included in a transmission parameter instruction section in a data transmitting apparatus according to the above Embodiment 1;

FIG. 11 illustrates a relationship between a transmission rate, a modulation scheme, and a coding rate of a data transmitting apparatus according to the above Embodiment 1;

FIG. 12 is a control sequence diagram showing a TCP transmission/reception control in a data transmitting apparatus according to the above Embodiment 1;

FIG. 13 is a block diagram showing a configuration of a data transmitting apparatus according to Embodiment 2 of the present invention; and

FIG. 14 is a block diagram showing a configuration of a data transmitting apparatus according to Embodiment 3 of the present invention.

### DESCRIPTION OF EMBODIMENTS

Embodiments according to the present invention will be described below in detail with reference to the drawings.

### Embodiment 1

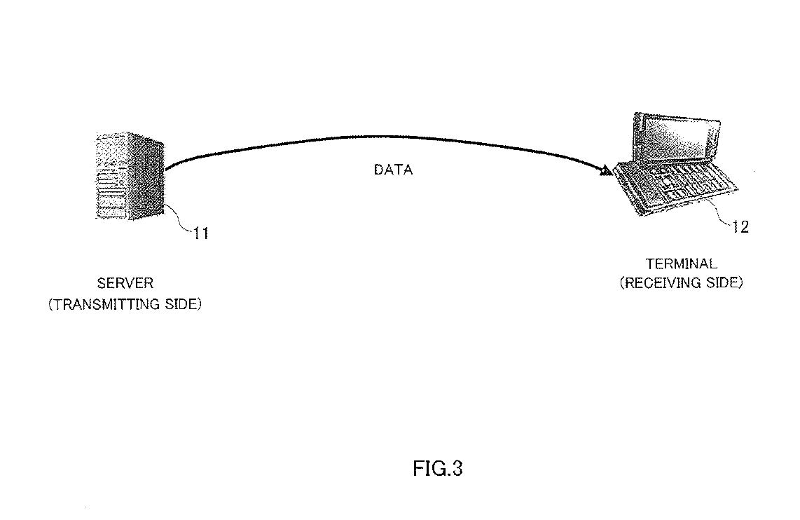

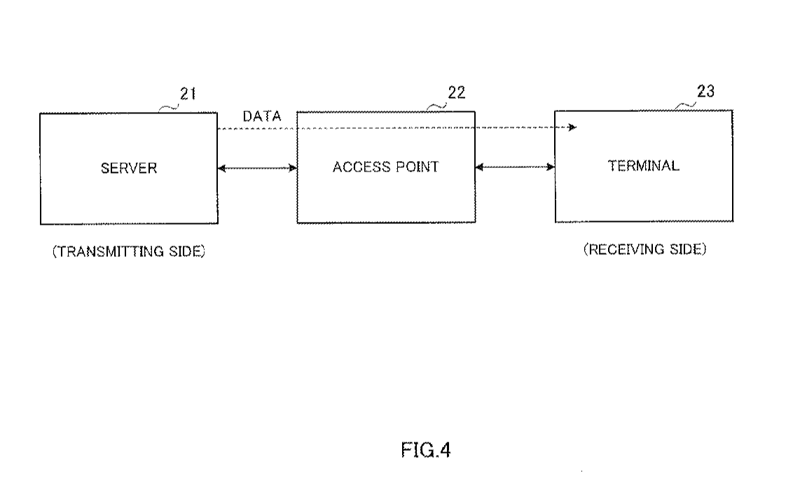

FIG. 3 and FIG. 4 are diagrams showing an example of a system configuration that a data transmitting apparatus according to Embodiment 1 of the present invention is applied.

FIG. 3 shows an example of a system configuration that server 11 and terminal 12 such as a mobile phone are directly connected. Server 11 in a transmitting side transmits data to terminal 12 in a receiving side and terminal 12 receives the data from server 11. Terminal 12 in the receiving side is, for example, a mobile terminal and required to have low power consumption.

FIG. 4 shows an example of a system configuration that server 21 and access point 22 are connected, and terminal 23 such as a mobile phone is connected to server 21 through access point 22. Data is transmitted from server 21 in the transmitting side to terminal 23 in the receiving side through access point 22, and terminal 23 receives data from server 21.

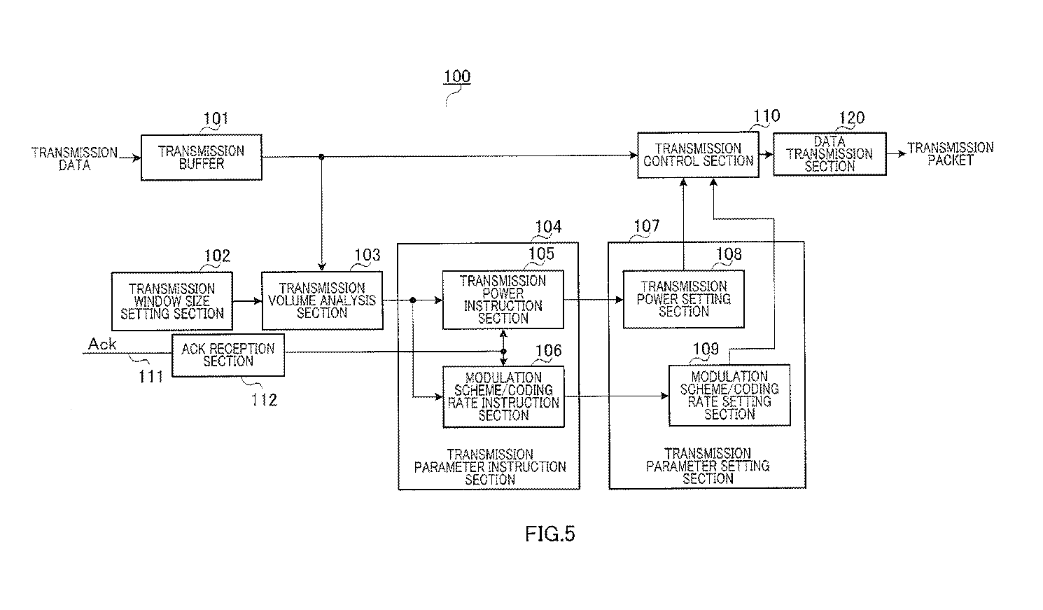

FIG. 5 is a diagram showing a configuration of the data transmitting apparatus according to Embodiment 1 of the present invention. The data transmitting apparatus according to the present embodiment is an example applied to the data transmitting apparatus in the system configuration shown in FIG. 3 and FIG. 4. The data transmitting apparatus according to the present embodiment is applicable to a transmission terminal in a home network.

As shown in FIG. 5, data transmitting apparatus 100 includes transmission buffer 101, transmission window size setting section 102, Ack reception section 112, transmission volume analysis section 103, transmission parameter instruction section 104, transmission power instruction section 105, modulation scheme/coding rate instruction section 106, transmission parameter setting section 107, transmission power setting section 108, modulation scheme/coding rate setting section 109, transmission control section 110, and data transmission section 120.

Ack signal 111 is entered into Ack reception section 112. Ack reception section 112 receives Ack signal 111 and outputs Ack signal 111 to transmission power instruction section 105 and modulation scheme/coding rate instruction section 106.

Data transmitting apparatus 100 changes transmission parameters depending on the data volume of transmitted packet relative to a transmission window size and transmits transmission data.

Transmission buffer 101 buffers transmission data from a memory (not shown in FIG. 5). The above memory is connected to transmission buffer 101 and sequentially transfers stored transmission data to transmission buffer 101.

Transmission window size setting section 102 sets a transmission window size in transmission buffer 101.

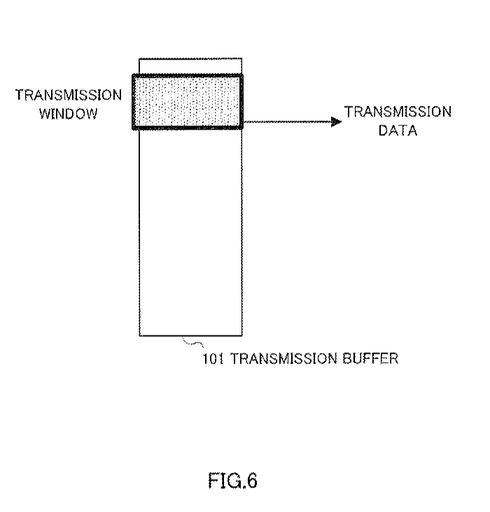

FIG. 6 illustrates a transmission window size set in transmission buffer 101. The transmission window size is set, for example, in association with a buffer capacity in the receiving side which is acquired from the receiving side when a communication connection is established.

Transmission volume analysis section 103 analyzes the data volume of transmitted packet relative to the transmission window size set in transmission window size setting section 102.

Transmission parameter instruction section 104 indicates set values of parameters to transmission parameter setting section 107 depending on the analytical result in transmission volume analysis section 103. Transmission parameter instruction section 104 indicates different transmission powers, modulation schemes, and coding rates to transmission parameter setting section 107 depending on a ratio of the data volume of the transmitted packet relative to the transmission window size.

Transmission parameter instruction section 104 is formed of transmission power instruction section 105 and modulation scheme/coding rate instruction section 106.

Transmission power instruction section 105 receives information on a proportion of the transmitted data volume, from transmission volume analysis section 103. Transmission power instruction section 105 indicates a set value of a transmission power to transmission power setting section 108 based on the received proportion of the volume of transmitted data.

Modulation scheme/coding rate instruction section 106 receives information on a proportion of the transmitted data volume, from transmission volume analysis section 103. Modulation scheme/coding rate instruction section 106 indicates a modulation scheme and a coding rate to modulation scheme/coding rate setting section 109 based on the received proportion of the transmitted data volume.

Transmission parameter setting section 107 sets transmission parameters instructed by transmission parameter instruction section 104. Transmission parameter setting section 107 sets transmission parameters for transmitting transmission data in transmission control section 110.

Transmission parameter setting section 107 is formed of transmission power setting section 108 and modulation scheme/coding rate setting section 109.

Transmission power setting section 108 receives a set value of a transmission power from transmission power instruction section 105 and sets the value.

Modulation scheme/coding rate setting section 109 receives set values of a modulation scheme and a coding rate from modulation scheme/coding rate instruction section 106 and sets the values.

Transmission control section 110 reads transmission data from transmission buffer 101 and controls transmission data based on the setting of transmission parameter setting section 107.

Data transmission section 120 transmits the transmission data received from transmission control section 110.

Transmission control section 110 may be connected to a network interface section (not shown). The above network interface section is connected to transmission control section 110 and an outside access point, and transmits transmission data transmitted from transmission control section 110 to the outside access point.

Hereinafter, an operation of data transmitting apparatus 100 configured as described above will be explained.

Data transmitting apparatus 100 depending on the present embodiment includes transmission parameter instruction section 104 which indicates set values of parameters to transmission parameter setting section 107, depending on the analytical result in transmission volume analysis section 103, and transmission parameter setting section 107 which sets the parameters instructed by transmission parameter instruction section 104.

Transmission parameter instruction section 104 indicates set values of parameters and transmission parameter setting section 107 sets the instructed parameters, thereby enabling the following transmission control. Hereinafter, an example of a transmission control of data transmitting apparatus 100 will be described.

(Control 1)

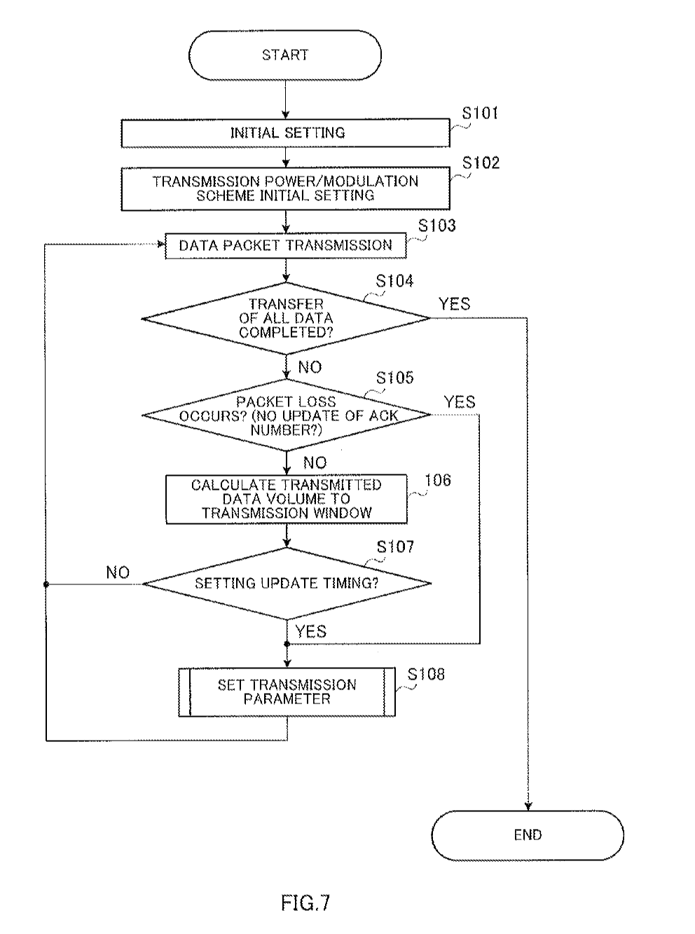

FIG. 7 is a flowchart showing a transmission control of data transmitting apparatus 100.

In step S101, transmission buffer 101 performs an initial setting process for buffering transmission data as shown in FIG. 7. Transmission window size setting section 102 performs an initial setting process for setting a transmission window size determined in a TCP flow control.

In step S102, transmission power instruction section 105 and modulation scheme/coding rate instruction section 106, respectively, perform initial setting processes on a transmission power and a modulation scheme.

In step S103, transmission buffer 101 transmits a data packet.

In step S104, transmission volume analysis section 103 determines whether or not all data have been transferred. When all data have been transferred, this flow ends.

Transmission volume analysis section 103 calculates a ratio of the data volume of the transmitted packet relative to a transmission window size, from the volume of transmission data read from transmission buffer 101 and the transmission window size set in transmission window size setting section 102.

If all data have not been transferred, transmission parameter instruction section 104 determines whether or not a packet loss occurs in step S105. The occurrence of the packet loss is determined from, for example, the absence of an update of an Ack number. The flow proceeds to step S108 if a packet loss occurs in transmission parameter instruction section 104, and proceeds to step S106 if a packet loss does not occur in transmission parameter instruction section 104.

In step S106, transmission volume analysis section 103 calculates transmitted data volume relative to the transmission window.

In step S107, transmission parameter instruction section 104 determines whether or not the current state is at timing for updating the settings. If it is not at the timing for updating the settings, the flow returns to the above step S103, and if it is at the timing for updating the settings, the flow proceeds to step S108.

In step S108, transmission parameter instruction section 104 sets transmission parameters, and the flow returns to step S103.

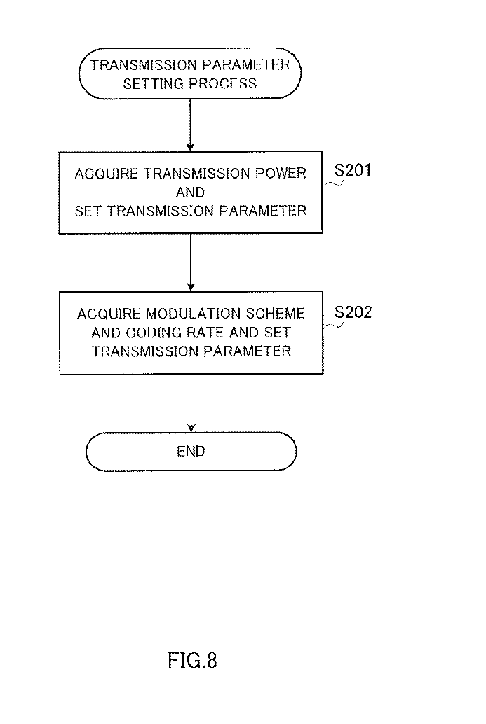

FIG. 8 is a flowchart showing a transmission parameter setting process in transmission parameter setting section 107. The flowchart showing the transmission parameter setting process in FIG. 8 is the subroutine of step S108 in FIG. 7.

Transmission power instruction section 105 and modulation scheme/coding rate instruction section 106 receive the information on the proportion of the transmitted data volume, from transmission volume analysis section 103.

In step S201, transmission power instruction section 105 indicates a set value of a transmission power to transmission power setting section 108. Transmission power setting section 108 receives the set value of the transmission power from transmission power instruction section 105 and sets the value.

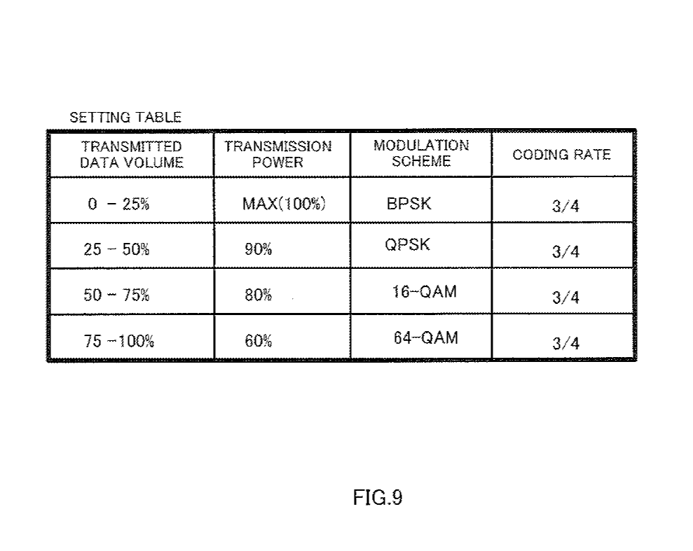

FIG. 9 shows a table for setting values of transmission parameters based on the proportion of the transmitted data volume.

In the setting table shown in FIG. 9, a transmission power, a modulation scheme, and a coding rate are set for each proportion of the transmitted data volume.

Transmission power instruction section 105 instructs transmission power setting section 108 to set a transmission power with reference to the setting table shown in FIG. 9. Specifically, transmission power instruction section 105, for example, instructs transmission power setting section 108 to set a maximum transmission power when the received information on the proportion of the transmitted data volume is equal to or more than 0% and less than 25%, and to set a transmission power of 90% of a maximum value when the received information on the proportion of the transmitted data volume is equal to or more than 25% and less than 50%. Transmission power instruction section 105 instructs transmission power setting section 108 to set a transmission power based on the received proportion of the transmitted data volume. Specifically, transmission power instruction section 105 instructs transmission power setting section 108 to set a transmission power of 80% of a maximum value, when the received information on the proportion of the transmitted data volume is equal to or more than 50% and less than 75%, and to set a transmission power of 60% of a maximum value, when the received information on the proportion of the transmitted data volume is equal to or more than 75% and equal to or less than 100%. Transmission power instruction section 105 may first increase, a transmission power by, for example, 20 to 30% to a preset transmission power and then gradually decrease the transmission power up to the preset transmission power, depending on the received proportion of the transmitted data volume.

Transmission power instruction section 105 may change the set values so as to increase the transmission power when a packet data loss occurs in a transmission using the instructed set values.

Transmission power instruction section 105, for example, updates the set value of the transmission power to 62% of a maximum value so as to increase the transmission power, when a packet data loss occurs in a case where the set value of the transmission power is 60% of the maximum value. Transmission power instruction section 105 updates the set value of transmission power to 64% so as to further increase the transmission power when a packet loss occurs again.

In step S202 in FIG. 8, modulation scheme/coding rate instruction section 106 indicates a modulation scheme and a coding rate to modulation scheme/coding rate setting section 109 based on the received proportion of the transmitted data volume. Modulation scheme/coding rate setting section 109 receives the set values of the modulation scheme and the coding rate from modulation scheme/coding rate instruction section 106 and sets the values.

Modulation scheme/coding rate instruction section 106, for example, indicates a condition of a modulation scheme to modulation scheme/coding rate setting section 109 with reference to the setting table shown in FIG. 9. Specifically, modulation scheme/coding rate instruction section 106 indicates a BPSK as a modulation scheme and a coding rate of 3/4 for the condition of the modulation scheme, to modulation scheme/coding rate setting section 109, when the received information on the proportion of the transmitted data volume is equal to or more than 0% and less than 25%. Modulation scheme/coding rate instruction section 106 indicates a QPSK as a modulation scheme and a coding rate of 3/4, to modulation scheme/coding rate setting section 109, when the received information on the proportion of the transmitted data volume is equal to or more than 25% and less than 50%. Modulation scheme/coding rate instruction section 106 indicates a 16-QAM as a modulation scheme and a coding rate of 3/4, to modulation scheme coding rate setting section 109, when the received information on the proportion of the transmitted data volume is equal to or more than 50% and less than 75%. Modulation scheme/coding rate instruction section 106 indicates a 64-QAM as a modulation scheme and a coding rate of 3/4, to modulation scheme coding rate setting section 109, when the received information on the proportion of the transmitted data volume is equal to or more than 75% and equal to or less than 100%.

Modulation scheme/coding rate instruction section 106 further changes set values so as to provide high error robustness when a packet data loss occurs in a transmission using the instructed set values.

Modulation scheme/coding rate instruction section 106, for example, updates the set values to values corresponding to a 64-QAM modulation scheme for a modulation scheme and a coding rate of 2/3 that provide high error robustness, when a packet data loss occurs in using set values corresponding to a 64-QAM modulation scheme and a coding rate of 3/4. Modulation scheme/coding rate instruction section 106 updates set values to set values corresponding to a 16-QAM modulation scheme and a coding rate of 3/4 so as to provide further high error robustness when the packet data loss occurs again.

Transmission power instruction section 105 and modulation scheme/coding rate instruction section 106 determine an occurrence of a packet data loss in accordance with an operation of a TCP flow control which detects the occurrence of the packet data loss by a reception of a duplicate Ack. Specifically, transmission power instruction section 105 and modulation scheme/coding rate instruction section 106 determine an occurrence of a packet loss when the received packet number of a received Ack is not updated from the received packet number of the previously received Ack.

Transmission parameter setting section 107 includes transmission power setting section 108 and modulation scheme coding rate setting section 109.

Transmission power setting section 108 receives the set value of the transmission power from transmission power instruction section 105 and sets the value.

Modulation scheme/coding rate setting section 109 receives the set values of the modulation scheme and the coding rate from modulation scheme/coding rate instruction section 106 and sets the values.

Transmission control section 110 reads transmission data buffered in transmission buffer 101 and transmits the transmission data in accordance with the settings in transmission power setting section 108 and modulation scheme/coding rate setting section 109.

The above control allows data to be adaptively transmitted based on the proportion of the data volume of the transmitted packet every time data equivalent to transmission window size is transferred, and to be transmitted with a high transmission power, and a modulation scheme and a coding rate which have high error robustness. Accordingly, the present embodiment makes it possible to suppress a packet data loss in an early step of a transfer.

Although the above description employs the high transmission power, and the modulation scheme and the coding rate which have high error robustness at the same time, at least one of them may be employed.

Consequently, the receiving side can shorten a period for which the receiving side continues to return a duplicate Ack every packet data reception when a packet data loss occurs, and therefore, it is possible to reduce a load in a data transmitting apparatus and suppress a power increase in a reception terminal.

(Control 2)

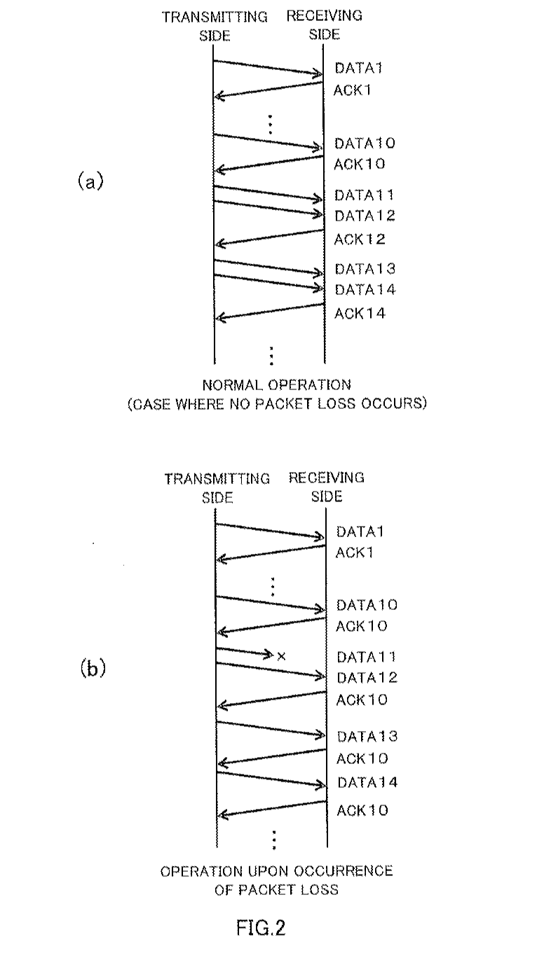

As shown in FIG. 2 (a), a reception terminal returns an Ack every time receiving data at an initial stage in a conventional TCP protocol operation. The reception terminal further returns one Ack for a plurality of data receptions when data reception proceeds and is stably performed. In FIG. 2 (a), the reception terminal returns one Ack for two data receptions.

As shown in FIG. 2 (b), the reception terminal returns the Ack for every data reception after a packet loss occurrence in the conventional TCP protocol operation. For this reason, in a method of a conventional technique, the packet loss in an earlier step of the transfer causes a larger influence and increases a power consumption with an increase in the number of Ack transmissions. In view of the above, the number of Ack transmissions in a reception terminal increases after an occurrence of the packet loss, and a load in a transmission terminal and a power consumption in the reception terminal increase in the conventional technique.

The present embodiment (1) performs a transmission by increasing a transmission power in the start of a transfer and, then decreasing the transmission power later, when data equivalent to a transmission window size is transferred, based on the data volume of the transmitted packet relative to the transmission window size. Alternatively, the present embodiment (2) performs a transmission with a high error correction performance in the start of a transfer and then with a low error correction performance.

Transmission parameter instruction section 104 indicates set values of parameters for carrying out the above (1) and (2), and transmission parameter setting section 107 sets the parameters instructed by transmission parameter instruction section 104. Here, the parameters may be indicated and set by selecting and setting either one or both of a transmission power in the above (1) and a modulation scheme/a coding rate in the above (2).

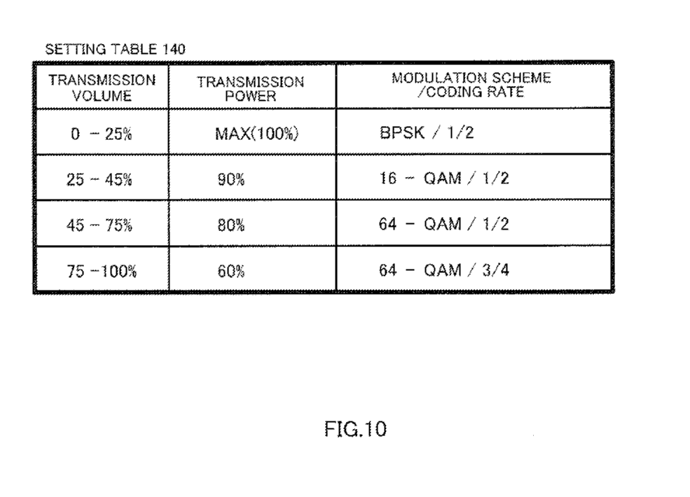

FIG. 10 shows a setting table included in transmission parameter instruction section 104.

As shown in FIG. 10, transmission parameter instruction section 104 includes setting table 140, and selects and indicates a transmission power and a modulation scheme/a coding rate depending on the transmission volume with reference to setting table 140.

Setting table 140 stores transmission powers and modulation schemes/coding rates corresponding to the transmission volume. In setting table 140, for example, in a case where the transmission volume is 0-25%, a transmission power is MAX (100%), a modulation scheme is BPSK, and a coding rate is 1/2. In setting table 140, for example, in a case where the transmission volume is 25-45%, a transmission power is 90%, a modulation scheme is 16-QAM, and a coding rate is 1/2. In setting table 140, for example, in a case where the transmission volume is 45-75%, a transmission power is 80%, a modulation scheme is 64-QAM, and a coding rate is 1/2. In setting table 140, for example, in a case where the transmission volume is 75-100%, a transmission power is 60%, a modulation scheme is 64-QAM, and a coding rate is 3/4. There are various setting methods in setting table 140. Details thereof will be described in Embodiment 3.

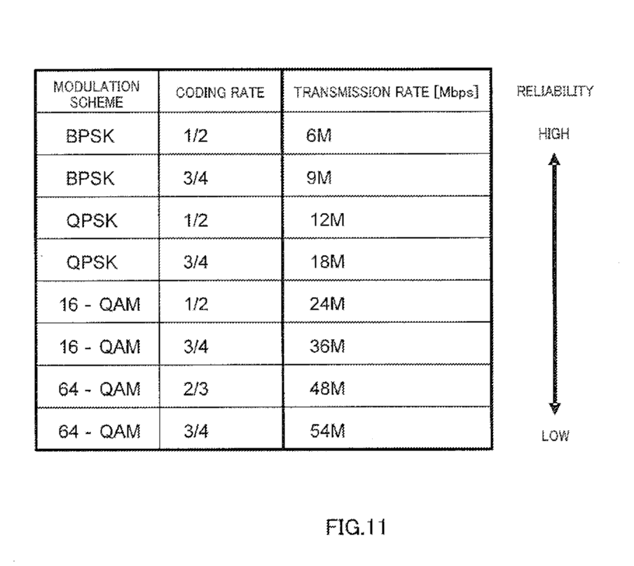

FIG. 11 is a diagram for explaining a relationship between a transmission rate, a modulation scheme, and a coding rate.

As shown in FIG. 11, a coding rate and a transmission rate [Mbps] vary for each modulation scheme. A modulation scheme having a smaller coding rate or a lower transmission rate [Mbps] has higher reliability. A BPSK modulation scheme, for example, has a coding rate of 1/2, a transmission rate of 6M [Mbps], and has the highest reliability related to a packet data transmission. On the other hand, 64-QAM has the highest coding rate and transmission rate [Mbps], and therefore a possibility that a packet loss occurs increases due to the high coding rate and transmission rate [Mbps], and reliability related to a packet data transmission decreases.

As described above, the present embodiment (1) performs a transmission by increasing a transmission power in the start of a transfer and then decreasing transmission power later, every time data equivalent to a transmission window size is transferred, based on the data volume of the transmitted packet relative to the transmission window size. Alternatively, the present embodiment (2) performs a transmission with a high error correction performance in the start of a transfer and then with a low error correction performance.

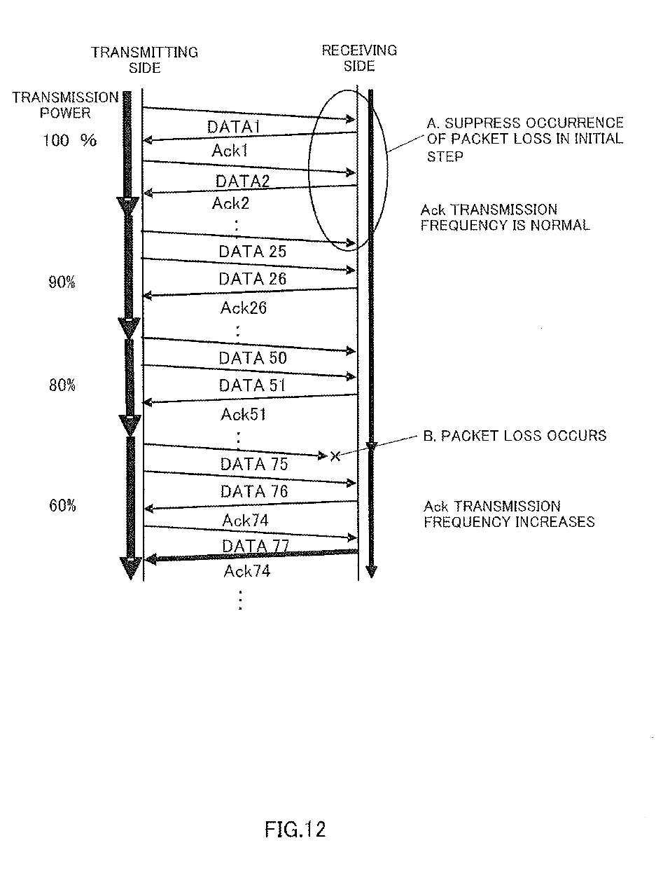

FIG. 12 is a control sequence diagram showing a TCP transmission/reception control according to the present embodiment. FIG. 12 shows an example of increasing a transmission power in the start of a transfer (MAX100%), every time data equivalent to a transmission window size is transferred, based on the data volume of the transmitted packet relative to the transmission window size. In this case, a transmission control for increasing a reliability may be performed by combining a modulation scheme having high reliability and may be performed only by a modulation scheme instead of a transmission power.

As shown in FIG. 12, the transmitting side increases a transmission power in the start of a transfer (MAX100%), every time data equivalent to a transmission window size is transferred. For example, when the number of data transmissions is over 25, the transmission power is decreased to 90%. For example, when the number of data transmissions is over 50, the transmission power is decreased to 80%. For example, the number of data transmissions is over 75, the transmission power is decreased to 60%.

A data transmission control according to the present embodiment can suppress an occurrence of a packet loss in the start of a transfer as shown in part a in FIG. 12. It is noted that a frequency of Ack transmission is normal.

In the present embodiment, it is assumed that setting a transmission power to 60% on the transmitting side facilitates the occurrence of a packet loss to cause the packet loss at the 75th data transmission, as shown in part b in FIG. 12. The receiving side returns an Ack for every data reception after the packet loss occurs. For this reason, the frequency of Ack transmission increases. However, the packet loss occurs in only a latter half of a data transfer with a transmission window size. This can suppress an occurrence of the packet loss in an early stage. Accordingly, the present embodiment can suppress the number of Ack transmissions in a reception terminal and reduce a power in the receiving side.

Here, information that a packet loss occurs when the transmitting side sets a transmission power to 60%, can be used for a subsequent data transmission control. Specifically, it is possible to perform a data transmission control for suppressing a packet loss, for example, by setting a transmission power to equal to or more than 60%, or transmitting data using a modulation scheme and a coding rate which have high error robustness, in the above described (control 1).

It is possible to suppress a packet data loss at an initial stage of a transfer by the above control that transmits data using a high transmission power and a modulation scheme and a coding rate which have high error robustness, in the initial stage of the transfer, every time data equivalent to a transmission window size is transferred.

Accordingly, the present embodiment can shorten a period for which the receiving side continues to return a duplicate Ack every packet data reception due to an occurrence of a packet loss, thereby making it possible to suppress a power increase.

As described above in detail, data transmitting apparatus 100 according to the present embodiment includes transmission volume analysis section 103 which analyzes the data volume of the transmitted packet relative to a transmission window size set in transmission window size setting section 102. Data transmitting apparatus 100 includes transmission parameter instruction section 104 which indicates different transmission powers, modulation schemes, and coding rates to transmission parameter setting section 107 depending on the ratio of the data volume of the transmitted packet relative to the transmission window size. Data transmitting apparatus 100 includes transmission parameter setting section 107 which sets parameters instructed by transmission parameter instruction section 104. Data transmitting apparatus 100 includes transmission control section 110 which reads transmission data from transmission buffer 101 and transmits transmission data based on the setting in transmission parameter setting section 107.

Transmission parameter instruction section 104 indicates different transmission powers, modulation schemes, and coding rates to transmission parameter setting section 107 depending on a ratio of the data volume of the transmitted packet relative to a transmission window size. Transmission parameter setting section 107 sets the instructed parameters and transmission control section 110 transmits transmission data based on the setting.

This allows data transmitting apparatus 100 to suppress a packet data loss in the initial stage of a transfer when data equivalent to a transmission window size is transferred. As a result, data transmitting apparatus 100 can suppress an increase in the number of duplicate Ack transmissions in the receiving side and reduce a load in a data transmitting apparatus and a power consumption in reception terminal.

Transmission parameter instruction section 104 according to the present embodiment is configured to include transmission power instruction section 105 and modulation scheme/coding rate instruction section 106, but may be configured to include only one of them. In line with the above, transmission parameter setting section 107 may be configured to include only one of transmission power setting section 108 and modulation scheme coding rate setting section 109.

Initial setting values are not limited to the above examples, but may be determined optionally depending on a state and configuration of the apparatus.

There has been described with a focus on TCP as a protocol including a flow control, but a protocol used for the present invention is not limited to the TCP. The present invention may employ any other protocols having a flow control function. It is applicable to reduce a power consumption by, for example, implementing a flow control in an application layer and performing a transmission control similar to TCP by the flow control.

### Embodiment 2

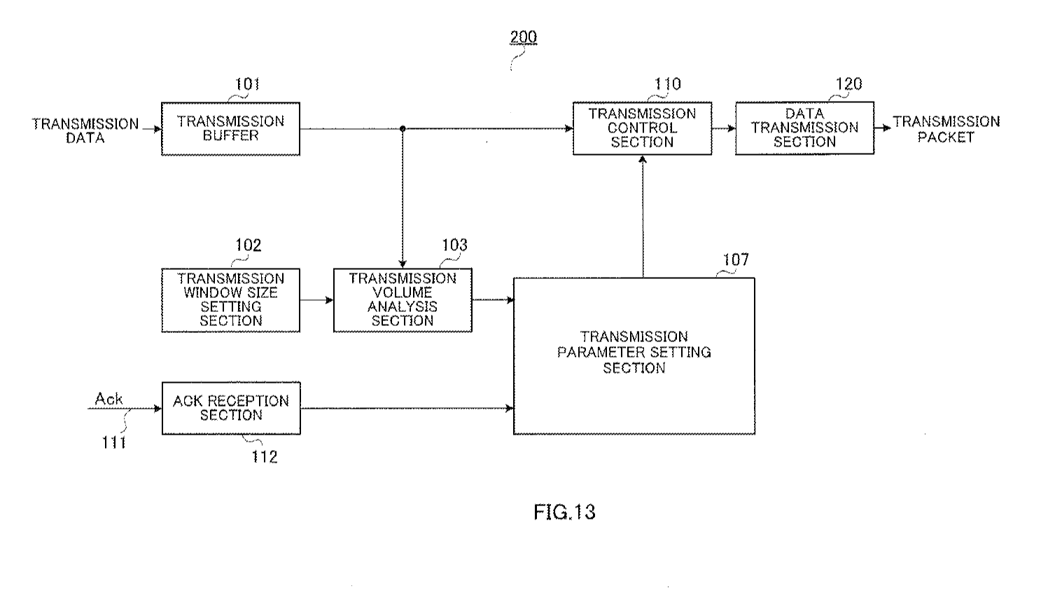

FIG. 13 is a block diagram showing a configuration of a data transmitting apparatus according to Embodiment 2 of the present invention. Components identical to those in FIG. 5 are assigned the same reference numerals, and duplicate descriptions are omitted here.

As shown in FIG. 13, data transmitting apparatus 200 includes transmission butter 101, transmission window size setting section 102, Ack reception section 112, transmission volume analysis section 103, transmission parameter setting section 107, transmission power setting section 108, modulation scheme coding rate setting section 109, transmission control section 110, and data transmission section 120.

Hereinafter, an operation of data transmitting system 200 configured as described above will be explained. A basic operation of data transmitting system 200 is similar to the operation in Embodiment 1.

Transmission buffer 101 buffers transmission data.

Transmission window size setting section 102 sets a transmission window size determined by TCP flow control.

Transmission volume analysis section 103 calculates a ratio of the data volume of the transmitted packet relative to a transmission window size, from the volume of transmission data read from transmission buffer 101 and the transmission window size set in transmission window size setting section 102.

Transmission parameter setting section 107 sets transmission parameters for transmitting transmission data depending on a result in transmission volume analysis section 103.

Transmission control section 110 reads transmission data buffered in transmission buffer 101 and transmits the transmission data in accordance with the settings in transmission power setting section 108 and modulation scheme coding rate setting section 109.

Data transmission section 120 transmits transmission data received from transmission control section 110.

In view of the above, the present embodiment allows data to be adaptively transmitted with a high transmission power and a modulation scheme and a coding rate which have high error robustness, based on the proportion of the data volume of the transmitted packet data every time data equivalent to transmission window size is transferred, as the same as Embodiment 1. By this means, the present embodiment makes it possible to suppress a packet data loss in an early step of a transfer. Especially, the present embodiment transmits data using a high transmission power and a modulation scheme and a coding rate which have high error robustness in the initial stage of the transfer and therefore can suppress a packet data loss in the initial stage of the transfer.

### Embodiment 3

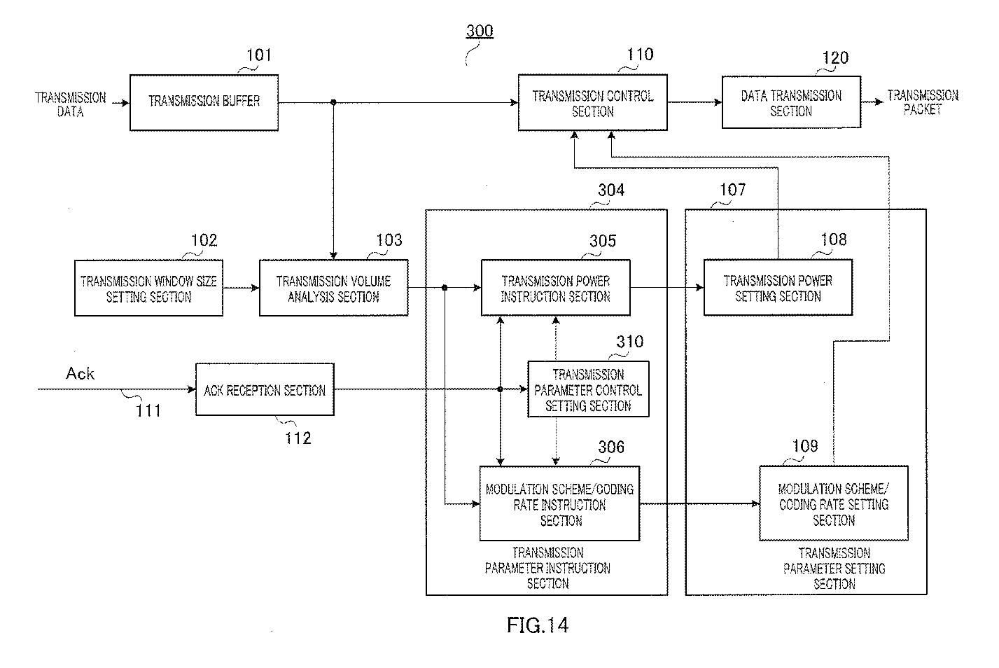

FIG. 14 is a block diagram showing a configuration of a data transmitting apparatus according to Embodiment 3 of the present invention.

In data transmitting apparatus 300, a configuration of transmission parameter instruction section 304 differs from a configuration of transmission parameter instruction section 104 in FIG. 5, as shown in FIG. 14. Components identical to those in FIG. 5 are assigned the same reference numerals, and duplicate descriptions are omitted here. Transmission parameter instruction section 304 includes transmission power instruction section 305, modulation scheme/coding rate instruction section 306, and transmission parameter control setting section 310.

Transmission power instruction section 305 receives information on a proportion of the transmitted data volume from transmission volume analysis section 103. Transmission power instruction section 305 indicates a set value of a transmission power to transmission power setting section 108 based on settings for, for example, an update procedure in transmission parameter control setting section 310 and the received proportion of the transmitted data volume.

Modulation scheme coding rate instruction section 306 receives information on the proportion of the transmitted data volume, from transmission volume analysis section 103. Modulation scheme coding rate instruction section 306 indicates a modulation scheme and a coding rate to modulation scheme coding rate setting section 109, based on the settings for, for example, the update procedure in transmission parameter control setting section 310 and the received proportion of the transmitted data volume.

Transmission parameter control setting section 310 sets the order of updating set values of the transmission power, the modulation scheme, and the coding rate. Specifically, transmission parameter control setting section 310 sets whether to update the transmission power, and the modulation scheme and the coding rate at the same time, update them alternately, or preferentially update either one of them, upon the update.

An operation of transmission parameter control setting section 310 will be described.

[Operation of Transmission Parameter Control Setting Section 310]

Transmission parameter control setting section. 310 sets the order of updating set values of a transmission power, and a modulation scheme and a coding rate. Specifically, transmission parameter control setting section 310 sets whether to update the transmission power, and the modulation scheme and the coding rate at the same time, update them alternately, or preferentially update either one of them, upon the update.

Transmission parameter control setting section 310, for example, sets an update procedure prioritizing the modulation scheme and the coding rate for a priority of a power in the transmitting side, in a case where the transmitting side is a battery-driving mobile terminal and so forth. This update procedure is set so as to preferentially update only a modulation scheme and coding rate without updating the transmission power.

Transmission parameter control setting section 310 prioritizes speeding up a communication rate in a case where the transmitting side is a stationary device which relatively need not prioritize a power. For this reason, in the stationary device, transmission parameter control setting section 310 sets the update procedure so as to prioritize update of only transmission power without updating the modulation scheme.

For example, when contents needs to be transmitted at a high transmission rate, the transmission power is preferentially controlled since updating of the modulation scheme and the coding rate may lower a transmission rate to disrupt a transfer.

In the above exemplary case, transmission parameter control setting section 310 sets the update procedure so as to update the transmission power, and the modulation scheme and the coding rate at the same time, but it is not necessary to update set values of the transmission power, and the modulation scheme and the coding rate at the same time. Transmission parameter control setting section 310 may set the update procedure so as to alternately update the transmission power, and the modulation scheme and the coding rate, or continue preferential update of either one of them.

In a case where the transmitting side is, for example, a battery-driving mobile terminal, a power in the transmitting side is prioritized. For this reason, transmission parameter control setting section 310 sets an update procedure prioritizing the modulation scheme and the coding rate so as to update only the modulation scheme and the coding rate without updating the transmission power.

In a case where the transmitting side is, for example, a stationary device which relatively need not prioritize a power, transmission parameter control setting section 310 sets an update procedure prioritizing the transmission power so as to update only the transmission, power without updating the modulation scheme, in order to prioritize speeding up a communication rate.

Accordingly, the receiving side can shorten a period for which the receiving side continues to return a duplicate Ack every packet data reception due to an occurrence of a packet data loss, thereby making it possible to suppress a power increase.

The above description is an illustration of preferred embodiments of the present invention and the scope of the invention is not limited to this.

Each function block of data transmitting apparatus 100 may be implemented as LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

The method of implementing multiplexed circuitry is not limited to LSI, and implementation by means of dedicated circuitry or a general-purpose processor may also be used. Utilization of a programmable FPGA (Field Programmable Gate Array) or a reconfigurable processor where connections and settings of circuit cells within LSI can be reconfigured is also possible.

In the event of the introduction of a multiplexed circuit implementation technology whereby LSI is replaced by a different technology as an advance in, or derivation from, semiconductor technology, integration of the function blocks may of course be performed using that technology. Application of biotechnology is also possible.

Although the present invention has been described in detail with reference to the specific embodiment, it is obvious for one of skill in the art that the present invention can be variously changed and modified without departing from the spilt and scope of the present invention.

The present embodiment employs the term “a data transmitting apparatus,” “a data transmitting system,” and “a data transmitting method,” but this is simply for convenience of description, “a transmitting apparatus,” and “a communication system,” may be employed for a device and “a transmission control method” and the like may be employed for a method.

In addition, the type, the number, the connection method and so forth of each of parts constituting the above-described data transmission apparatus, such as a network protocol control section, are not limited.

In addition, the above-described data transmission method may be realized by a program to operate this data transmission method. This program is stored in a computer-readable storage medium.

The disclosure of Japanese Patent Application No. 2010-138349, filed on Jun. 17, 2010, including the specification, drawings and abstract, is incorporated herein by reference in its entirety.

### INDUSTRIAL APPLICABILITY

A data transmitting apparatus and a data transmitting method according to the present invention provide an advantage of suppressing the number of Ack transmissions in a receiving side and are useful for devices such as devices which have a server function with a wireless LAN function. The above embodiments can be applied to devices which employ a communication method, compliant to TCP other than the wireless LAN.

### REFERENCE SIGNS LIST

100, 200, 300 Data transmitting apparatus
101 Transmission buffer
102 Transmission window size setting section
103 Transmission volume analysis section
104, 304 Transmission parameter instruction section
105, 305 Transmission power instruction section
106, 306 Modulation scheme coding rate instruction section
107 Transmission parameter setting section
108 Transmission power setting section
109 Modulation scheme coding rate setting section
200 Data transmitting system
310 Transmission parameter control setting section

1. A data transmitting apparatus comprising:
a transmission buffer that buffers transmission data;
a transmission window size setting section that sets a transmission window size in the transmission buffer;
a transmission volume analysis section that analyzes the data volume of a transmitted packet relative to the transmission window size set in the transmission window size setting section;
a transmission parameter setting section that sets one or more transmission parameters for transmitting the transmission data, depending on the analytical results in the transmission volume analysis section;
a transmission control section that reads the transmission data from the transmission buffer and transmits the transmission data based on the transmission parameters; and
a data transmission section that transmits the transmission data received from the transmission control section.

2. The data transmitting apparatus according to claim 1, wherein the transmission parameter setting section sets at least one of a value of transmission power, a type of a modulation scheme, and a value of a coding rate for data transmission in the transmission control section, as the transmission parameter, depending on the data volume of transmitted packet in the transmission volume analysis section.

3. The data transmitting apparatus according to claim 1, wherein the transmission parameter setting section receives an acknowledgement being a response to the transmission data and changes the parameter depending on a packet number of the acknowledgement.

4. The data transmitting apparatus according to claim 1, wherein the transmission parameter setting section changes at least one of the parameters to a set value robust to a packet loss, when a packet data loss occurs as a result of a transmission using the set parameter.

5. The data transmitting apparatus according to claim 1, wherein the transmission parameter setting section sets at least one of the parameters to a set value robust to packet loss, at an initial stage of a transfer.

6. A data transmitting method in a data transmitting apparatus for transmitting transmission data, the method comprising the steps of:
buffering the transmission data in a transmission buffer;
setting a transmission window size in the transmission buffer;
analyzing the data volume of a transmitted packet relative to the set transmission window size;
setting a transmission parameter for transmitting the transmission data depending on the analytical result;
reading the transmission data from the transmission buffer and transmitting the transmission data based on the transmission parameter; and
transmitting the transmission data received from the transmission control section.

7. The data transmitting method according to claim 6, wherein, in the step of setting the transmission parameter, the transmission parameter is changed so as to provide a high transmission power and/or high error robustness, when a packet data loss occurs.

8. The data transmitting method according to claim 6, wherein, in the step of setting the transmission parameter, the transmission parameter is set so as to provide a high transmission power and/or a modulation scheme and/or a coding rate having high error robustness, at an initial stage of a transfer.
